(19) United States
(12) Patent Application Publication
(10) Pub. No.: US 2023/0406066 A1
(43) Pub. Date: Dec. 21, 2023

(54) HEATING AND COOLING SYSTEM FOR A VEHICLE

(71) Applicant: Rheinmetall Invent GmbH, Neuss (DE)

(72) Inventors: Carmelo Veneziano, Untereisesheim (DE); Gleb Zaikin, Boxberg (DE); Karl-Heinz Hassel, Oestringen (DE); Kamil Kaiser, Neckarsulm (DE)

(73) Assignee: Rheinmetall Invent GmbH, Neuss (DE)

(21) Appl. No.: 18/035,475

(22) PCT Filed: Nov. 4, 2021
(86) PCT No.: PCT/EP21/80674

§ 371 Date: May 4, 2023

(30) Foreign Application Priority Data
Nov. 6, 2020 (DE) 10 2020 129 328.3

(51) Int. Cl. B60H 1/00; B60H 1/32

(52) U.S. Cl. CPC B60H 1/00907; B60H 1/32284; B60H 1/00542; B60H 2001/00928; B60H 2001/00935

(57) ABSTRACT

A heating and cooling system (4A, 4B, 4C, 4D) for a vehicle (1), comprising a heating and cooling module (6) comprising a refrigerant circuit (7), and a refrigerant-air heat exchanger (22) fluidly connected to the refrigerant circuit (7) for tempering a vehicle interior (3) of the vehicle (1), the refrigerant-air heat exchanger (22) being provided outside the heating and cooling module (6).

### CROSS-REFERENCE TO RELATED APPLICATIONS

This application is for entry into the U.S. National Phase from which priority is claimed under all applicable sections of Title 35 of the United States Code including, but not limited to, Sections 120, 363, and 365(c) to International Application Serial No. PCT/EP2021/080674, filed on Nov. 4, 2021 and entitled “HEATING AND COOLING SYSTEM FOR A VEHICLE,” which in turn claims priority to German Patent Application Serial No. DE 10 2020 129 328.3, filed on Nov. 6, 2020 and entitled “HEIZ-UND KUHLSYSTEM SOWIE FAHRZEUG.” Each of International Application Serial No. PCT/EP2021/080674 and German application Serial No. DE 10 2020 129 328.3 is incorporated by reference herein in its entirety.

### FIELD OF THE INVENTION

The present invention relates to a heating and cooling system for a vehicle and to a vehicle, in particular an electric vehicle or a hybrid vehicle, comprising such a heating and cooling system.

### BACKGROUND

According to in-house findings, motor vehicles may comprise heating and cooling systems in which a refrigerant circuit can be operated as a heat pump and/or as a refrigerating machine. For this purpose, the refrigerant circuit comprises at least a compressor, a condenser, an evaporator and an expansion device. An advantage of such a heating and cooling system lies in the possibility of interconnecting and utilizing individual heat sources and heat sinks of the motor vehicle for tempering a vehicle interior.

In motor vehicles with a purely electric drive or a hybrid drive, however, such heat sources and heat sinks are not available, or are only available to a limited extent, for tempering the vehicle interior. This design-related disadvantage can be further exacerbated by environmental influences, for example if part of the heating and cooling system is frozen due to low outside temperatures and is thus not available to the heating and cooling system. Furthermore, in such motor vehicles, it may be necessary that not only the vehicle interior, but also various vehicle aggregates are tempered to maintain a certain temperature range.

DE 10 2013 109 666 A1 shows a heating and cooling system for motor vehicles with a refrigerant circuit designed as a heat pump and/or as a refrigerating machine, which has at least one main line through which a refrigerant can flow, a compressor, a condenser, an evaporator and at least one expansion device, it being possible to couple the condenser to a first coolant circuit and the evaporator to a second coolant circuit. Thereby, the evaporator of the refrigerant circuit is bypassable.

Against this background, one object of the present invention is to provide an improved heating and cooling system for a vehicle.

### SUMMARY OF THE DISCLOSURE

Accordingly, a heating and cooling system for a vehicle is proposed. The heating and cooling system comprises a heating and cooling module comprising a refrigerant circuit, and a refrigerant-air heat exchanger fluidly connected to the refrigerant circuit for tempering a vehicle interior of the vehicle, the refrigerant-air heat exchanger being provided outside the heating and cooling module.

Because the refrigerant-air heat exchanger is provided outside the heating and cooling module, it can be placed directly in or on the vehicle interior. This allows, for example, a direct heat transfer from the refrigerant circuit to an air flow flowing into the vehicle interior. An additional heat transfer by means of a coolant circuit connected between the refrigerant circuit and the vehicle interior with a refrigerant-coolant heat exchanger and a coolant-air heat exchanger can be dispensed with. This increases the efficiency of the heating and cooling system. By using the compact heating and cooling module instead of an arrangement with components spaced apart from each other, the amount of refrigerant required can be reduced. This is advantageous for ecological reasons, for example.

The heating and cooling system may also be referred to as thermal management system. The heating and cooling system is particularly suitable for tempering both the vehicle interior and further components of the vehicle, such as an accumulator, a drive engine or the like. The heating and cooling system may be part of an air conditioning system, in particular an automatic air conditioning system. In the present context, “tempering” may be understood to mean cooling and/or heating as required. The vehicle is preferably a motor vehicle, in particular an electric vehicle or a hybrid vehicle.

A “heating and cooling module” or, more generally, a “module” or “modular structure” is to be understood in particular as a compact and space-optimized arrangement in which all components of the heating and cooling module, such as a compressor, lines, throttles, valves, heat exchangers or the like, are placed as compactly as possible in the smallest possible space. This means, for example, that lines can be made as short as possible, which leads to a lower quantity of refrigerant required.

In particular, the compact heating and cooling module is block shaped, preferably cuboid or cube shaped, or cylindrical. The heating and cooling module thus fills a block shaped or cylindrical installation space. The heating and cooling module thus forms a unit, which can preferably be mounted on the vehicle as a component or assembly. In contrast to such a heating and cooling module, an arrangement can be seen in which the individual components of the heating and cooling system are placed at arbitrary locations on the vehicle and are thus arranged at a distance from one another. In the latter case, this does not result in a compact and modular structure.

The refrigerant circuit is preferably a closed circuit in which a refrigerant circulates. The refrigerant may be part of the heating and cooling system. A “refrigerant” transports enthalpy from a refrigerated product to the environment. The difference between this and a “coolant” is that a refrigerant in a refrigerant circuit may transport enthalpy along a temperature gradient such that, with the expenditure of supplied energy, the ambient temperature may even be higher than the temperature of the item being cooled, whereas a coolant is only capable of transporting enthalpy in a refrigeration circuit against the temperature gradient to a lower temperature location. For example, the refrigerant may be 1,1,1,2-Tetrafluoroethane (R-134a). However, any other refrigerant may be used. For example, water may be used as coolant.

In particular, the fact that the refrigerant-air heat exchanger is “in fluid communication” with the refrigerant circuit means in the present case that the refrigerant can flow from the refrigerant-air heat exchanger to the refrigerant circuit and vice versa. In the present context, a “refrigerant-air heat exchanger” means a heat exchanger suitable for transferring heat from the refrigerant directly to the air and vice versa. The refrigerant and the air do not come into direct contact with each other.

That the refrigerant-air heat exchanger is placed, arranged or provided “outside” the heating and cooling module means in particular in the present case that the refrigerant-air heat exchanger is not placed inside a space or installation space bounded by the heating and cooling module, but outside thereof. That is, the refrigerant-air heat exchanger is preferably placed or arranged at a distance from the heating and cooling module.

For example, the refrigerant-air heat exchanger may thus be placed in or on the vehicle interior and the heating and cooling module may be placed in or on an engine compartment of the vehicle. The heating and cooling module may include a cover or housing. In this case, the refrigerant-air heat exchanger is preferably arranged, placed or provided outside the cover or outside the housing.

According to an embodiment, the heating and cooling module comprises a reversing valve which can be switched from a first switching position, in which the heating and cooling module operates as a heat pump, into a second switching position, in which the heating and cooling module operates as a refrigeration apparatus, and vice versa.

Preferably, the reversing valve can be switched automatically. With the aid of the reversing valve, in particular a flow reversal of the refrigerant in the refrigerant circuit can be achieved. In the present context, a “heat pump” is to be understood as a device or machine which, using technical work, in particular with the aid of the compressor, absorbs thermal energy from a reservoir at a lower temperature and—together with the drive energy—transfers it as useful heat to a system to be heated at a higher temperature. This enables a particularly energy-saving operation of the heating and cooling system. A “refrigeration apparatus” or “refrigeration machine” uses a compressor to transport heat energy from a colder location to be cooled to a warmer environment. A refrigeration apparatus thus has the reverse functionality of a heat pump.

According to a further embodiment, the refrigerant-air heat exchanger functions as a condenser for heating the vehicle interior in the first switching position and as an evaporator for cooling the vehicle interior in the second switching position.

In the first switching position, the refrigerant condenses in the refrigerant-air heat exchanger in order to dissipate heat to the vehicle interior or to the air flowing into the vehicle interior. In other words, the vehicle interior is heated. In the second switching position, the refrigerant in the refrigerant-air heat exchanger evaporates in order to absorb heat from the vehicle interior or from the air flow flowing into the vehicle interior. In other words, the vehicle interior is cooled.

According to a further embodiment, the heating and cooling system further comprises a first coolant circuit which is in heat transfer with the refrigerant circuit by means of a first refrigerant-coolant heat exchanger, the first refrigerant-coolant heat exchanger acting as a condenser in the first switching position and as an evaporator in the second switching position.

A coolant, for example water, circulates in the coolant circuit. A “refrigerant-coolant heat exchanger” is understood to mean a heat exchanger which is suitable for transferring heat from a refrigerant to a coolant and vice versa. In this regard, the refrigerant and the coolant do not come into direct contact with each other. The fact that the first refrigerant-coolant heat exchanger is “in heat transfer” with the refrigerant circuit means in the present case that the first refrigerant-coolant heat exchanger or the first coolant circuit transfers heat to the refrigerant circuit or, conversely, that the refrigerant circuit transfers heat to the first refrigerant-coolant heat exchanger or to the first coolant circuit.

According to a further embodiment, the heating and cooling system further comprises a first coolant-air heat exchanger for tempering the vehicle interior, the first coolant-air heat exchanger being in fluid communication with the first coolant circuit.

A “coolant-air heat exchanger” is understood to mean a heat exchanger which is suitable for transferring heat from a coolant to the air and vice versa. The coolant and the air do not come into direct contact with each other. By means of the first coolant-air heat exchanger, the vehicle interior can be cooled or heated. The fact that the first coolant-air heat exchanger is “in fluid connection” with the first coolant circuit means in particular that the first coolant-air heat exchanger is part of the first coolant circuit.

According to a further embodiment, the refrigerant-air heat exchanger is connected upstream of the first refrigerant-air heat exchanger.

“Upstream” or “preceding” in this context means considered along the air flow entering the vehicle interior. The first coolant-air heat exchanger is thus placed downstream of the refrigerant-air heat exchanger. In the event that the refrigerant-air heat exchanger cools the air flow, the first coolant-air heat exchanger may reheat the air flow. In particular, this serves to dry the air flow and may be used to clear windows of the vehicle.

According to a further embodiment, the heating and cooling system further comprises a second coolant circuit which is in heat transfer with the refrigerant circuit by means of a second refrigerant-coolant heat exchanger, the second refrigerant-coolant heat exchanger acting as an evaporator in the first switching position and as a condenser in the second switching position.

In principle, the number of coolant circuits is arbitrary. The second coolant circuit is also filled with a coolant, in particular water. The fact that the second refrigerant-coolant heat exchanger is “in heat transfer” with the refrigerant circuit means in the present case that the second refrigerant-coolant heat exchanger or the second coolant circuit transfers heat to the refrigerant circuit or, conversely, that the refrigerant circuit transfers heat to the second refrigerant-coolant heat exchanger or to the second coolant circuit.

According to a further embodiment, the heating and cooling system further comprises a second coolant-air heat exchanger for tempering the vehicle interior, the second coolant-air heat exchanger being in fluid communication with the second coolant circuit.

With the aid of the second coolant-air heat exchanger, the vehicle interior can be either heated or cooled. The fact that the second coolant-air heat exchanger is “in fluid connection” with the second coolant circuit means in particular that the second coolant-air heat exchanger is part of the second coolant circuit.

According to a further embodiment, the refrigerant-air heat exchanger is connected upstream of the second coolant-air heat exchanger.

As previously mentioned, “upstream” means considered along the air flow entering the vehicle interior. The second coolant-air heat exchanger is thus placed downstream of the refrigerant-air heat exchanger.

According to a further embodiment, the second coolant circuit comprises a coolant-air heat exchanger for delivering and receiving heat to and from an environment of the heating and cooling system.

The first coolant circuit may comprise a similar coolant-air heat exchanger. For example, waste heat from drive components of the vehicle can be dissipated to the environment via the coolant-air heat exchanger.

According to a further embodiment, the heating and cooling system further comprises lines leading away from the heating and cooling module, the refrigerant-air heat exchanger being in fluid communication with the refrigerant circuit by means of the lines.

The lines may be flexible hoses or inflexible tubing. For example, the heating and cooling module is mounted in or on the engine compartment, and the refrigerant-air heat exchanger is mounted in or on the vehicle interior. In this case, the lines lead from the engine compartment to the vehicle interior. The lines are chosen to be as short as possible to minimize the amount of refrigerant taken up in the lines.

According to a further embodiment, the heating and cooling module is block shaped.

As previously mentioned, “block shaped” may be understood to be, for example, cuboid shaped, cube shaped or even cylindrical. The heating and cooling module thus fills a predefined block shaped installation space as a compact module, in which all components of the heating and cooling module are accommodated with the exception of the refrigerant-air heat exchanger arranged outside the heating and cooling module. The heating and cooling module may be mounted to the vehicle as a single component or assembly in a modular fashion.

Furthermore, a vehicle, in particular an electric vehicle or hybrid vehicle, is proposed. The vehicle comprises such a heating and cooling system, the refrigerant-air heat exchanger being provided in or on the vehicle interior.

“In or on the vehicle interior” thereby in particular also includes an area on or under a dashboard or other trim components or housings of the vehicle, in particular the vehicle interior, so that the refrigerant-air heat exchanger is preferably not visible from the vehicle interior. The vehicle is preferably a motor vehicle, in particular an electric vehicle or hybrid vehicle. However, the vehicle may also be a commercial vehicle, for example a truck. Further, the vehicle may also be an aircraft, a watercraft or a rail vehicle. Preferably, the vehicle comprises a body which delimits or encloses the interior of the vehicle.

According to an embodiment, the heating and cooling module is provided in or on an engine compartment of the vehicle.

Due to its compact modular design, the heating and cooling module can be easily and conveniently mounted in the engine compartment.

According to a further embodiment, the vehicle further comprises an accumulator and/or drive components, the heating and cooling system being configured to temper the accumulator and/or the drive components.

The drive components may comprise a drive motor, in particular an electric motor, a gearbox, or the like.

The embodiments and features described for the proposed heating and cooling system apply mutatis mutandis to the proposed vehicle, and vice versa.

“One” as used herein is not necessarily to be understood as being limited to exactly one element. Rather, multiple elements, such as two, three or more, may also be provided. Also, any other counting word used herein is not to be understood as limiting the number of elements to exactly that number. Rather, numerical variations upward and downward are possible unless otherwise indicated.

Further possible implementations of the heating and cooling system and/or the vehicle also comprise combinations, not explicitly mentioned, of features or embodiments described before or below with respect to the embodiments. In this regard, the skilled person will also add individual aspects as improvements or additions to the respective basic form of the heating and cooling system and/or the vehicle.

Further advantageous embodiments and aspects of the heating and cooling system and/or the vehicle are the subject of the sub-claims, as well as the embodiments of the heating and cooling system and/or the vehicle described below. Further on, the heating and cooling system and/or the vehicle will be explained in more detail by means of preferred embodiments with reference to the attached figures.

### BRIEF DESCRIPTION OF THE DRAWINGS

FIG. 1 shows a schematic view of an embodiment of a vehicle;

FIG. 2 shows a schematic view of an embodiment of a heating and cooling system for the vehicle according to FIG. 1;

FIG. 3 shows another schematic view of the heating and cooling system according to FIG. 2;

FIG. 4 shows a schematic view of a further embodiment of a heating and cooling system for the vehicle according to FIG. 1;

FIG. 5 shows a schematic view of a further embodiment of a heating and cooling system for the vehicle according to FIG. 1; and

FIG. 6 shows a schematic view of a further embodiment of a heating and cooling system for the vehicle according to FIG. 1.

In the figures, identical or functionally identical elements have been provided with the same reference signs, unless otherwise indicated.

### DETAILED DESCRIPTION

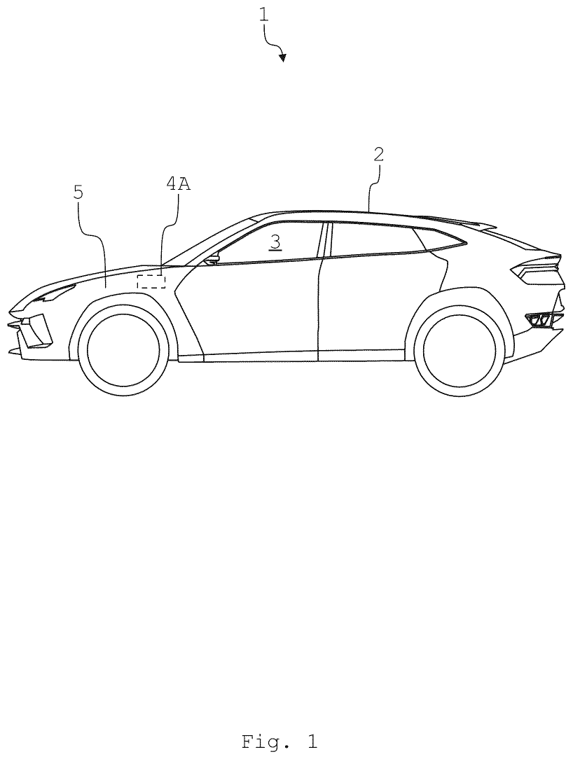

FIG. 1 shows a schematic view of an embodiment of a vehicle 1. The vehicle 1 is a motor vehicle, in particular an electric vehicle or hybrid vehicle. However, the vehicle 1 may also be a commercial vehicle, for example a truck. Furthermore, the vehicle 1 may also be an aircraft, a watercraft or a rail vehicle. In the following, however, it will be assumed that the vehicle 1 is a motor vehicle.

The vehicle 1 includes a body 2 enclosing a passenger compartment or vehicle interior 3 of the vehicle 1. The vehicle interior 3 may contain a driver and passengers. The vehicle 1 further comprises a heating and cooling system 4A for tempering the vehicle interior 3 and vehicle components, such as an engine, in particular an electric motor, or an accumulator.

In this context, “tempering” is understood to mean heating and/or cooling. The heating and cooling system 4A may also be referred to as a thermal management system. That is, the terms “heating and cooling system” and “thermal management system” may be interchanged as desired. The heating and cooling system 4A is at least partially housed in an engine compartment 5 of the vehicle 1.

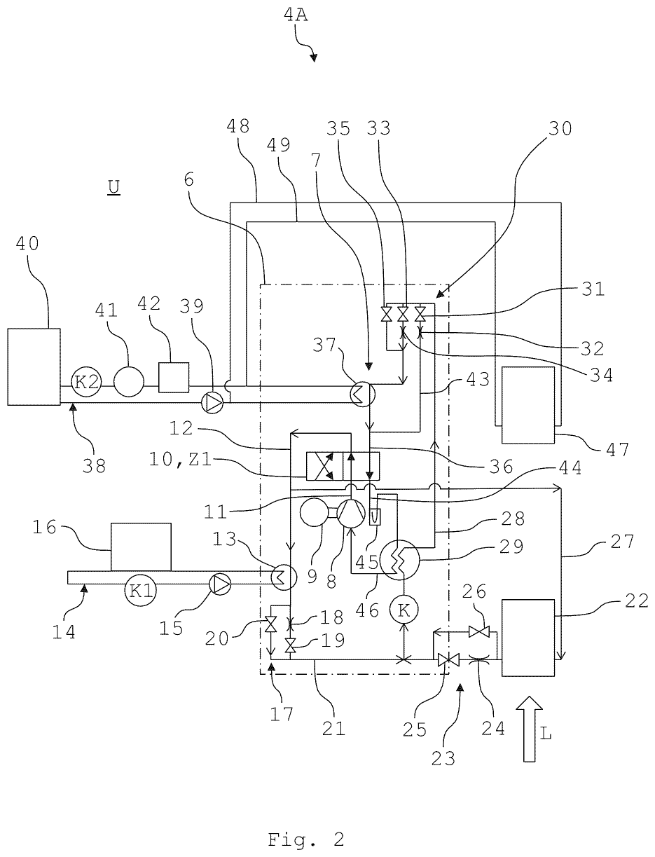

FIG. 2 shows a schematic view of an embodiment of a heating and cooling system 4A as previously mentioned. The heating and cooling system 4A comprises a compact heating and cooling module 6 housed, for example, in the engine compartment 5 of the vehicle 1. The heating and cooling module 6 comprises a refrigerant circuit 7 in which a refrigerant K circulates. The refrigerant K may be 1,1,1,2-Tetrafluoroethane (R-134a).

A “refrigerant” transports enthalpy from a refrigerated product to the environment. The difference to a “coolant” is that a refrigerant can transport enthalpy along a temperature gradient in a refrigerant circuit, so that the ambient temperature may even be higher than the temperature of the object to be cooled with the expenditure of supplied energy, whereas a coolant is only capable of transporting enthalpy in a coolant circuit against the temperature gradient to a point of lower temperature.

The refrigerant circuit 7 comprises a compressor 8 driven by a motor 9. Downstream of the compressor 8, a reversing valve 10 is provided. In FIG. 2, the reversing valve 10 is in a first switching position Z1. By means of the reversing valve 10, a flow direction of the refrigerant K in the refrigerant circuit 7 can be reversed. The compressor 8 is in fluid communication with the reversing valve 10 via a line 11. A line 12 leads away from the reversing valve 10 to a first refrigerant-coolant heat exchanger 13.

Via the first refrigerant-coolant heat exchanger 13, a first coolant circuit 14 is in heat exchange with the refrigerant circuit 7. A coolant K1, for example water, circulates in the first coolant circuit 14. The first coolant circuit 14 comprises a pump 15, for example the first coolant circuit 14 is adapted to remove heat from a battery or accumulator 16 of the vehicle 1.

Downstream of the first refrigerant-coolant heat exchanger 13, an expansion device 17 is provided which comprises a throttle 18 and a check valve 19 connected upstream of the throttle 18, and a further check valve 20 connected in parallel with the throttle 18 and the check valve 19.

Downstream of the expansion device 17, a line 21 leads to a refrigerant-air heat exchanger 22. The refrigerant-air heat exchanger 22 is an indoor heat exchanger. Upstream of the refrigerant-air heat exchanger 22 is an expansion device 23, which comprises a throttle 24 and a check valve 25 connected upstream of the throttle 24, and a check valve 26 connected in parallel with the throttle 24 and the check valve 25.

The refrigerant-air heat exchanger 22 is provided outside the heating and cooling module 6. In particular, the refrigerant-air heat exchanger 22 is located outside the engine compartment 5. The refrigerant-air heat exchanger 22 may be located in the vehicle interior 3. From the refrigerant-air heat exchanger 22, a line 27 leads back to the line 12 and opens into the line 12 between the reversing valve 10 and the first refrigerant-coolant heat exchanger 13.

A line 28 branches off from the line 21 and leads to a refrigerant-refrigerant heat exchanger 29. The line 28 leads through the refrigerant-refrigerant heat exchanger 29 or is part of the refrigerant-refrigerant heat exchanger 29.

Downstream of the refrigerant-refrigerant heat exchanger 29 is an expansion device 30, which comprises a check valve 31 and a throttle 32 connected in series with the check valve 31. Further, the expansion device 30 comprises another check valve 33 and a throttle 34 connected in series with the check valve 33. The check valve 33 and the throttle 34 are connected in parallel with the check valve 31 and the throttle 32. Further, the expansion device 30 comprises a check valve 35 connected in parallel with the check valves 31, 33.

A line 36 leads from the expansion device 30 to the reversing valve 10, and a second refrigerant-coolant heat exchanger 37 is provided on the line 36. The second refrigerant-coolant heat exchanger 37 allows heat transfer between the refrigerant circuit 7 and a second coolant circuit 38. A coolant K2 circulates in the second coolant circuit 38. The coolant K2 may be water.

The second coolant circuit 38 includes a pump 39 and a coolant-air heat exchanger 40. The second coolant circuit 38 may be used to remove heat from drive components 41, 42 of the vehicle 1. The drive components 41, 42 may comprise, for example, a drive motor, a drive train and/or electronic components.

An optional bypass line 43 leads from the throttle 32 to the line 36. The bypass line 43 can be used to bypass the second refrigerant-coolant heat exchanger 37. The bypass line 43 opens into the line 36 between the second refrigerant-coolant heat exchanger 37 and the reversing valve 10.

A line 44 leads from the reversing valve 10 to a collector 45. A line 46 leads from the collector 45 back to the reversing valve 10. The line 46 leads through the refrigerant-refrigerant heat exchanger 29 or is part of the refrigerant-refrigerant heat exchanger 29.

Optionally, the heating and cooling system 4A may comprise a coolant-air heat exchanger 47 which is in fluid communication with the second coolant circuit 38 by means of lines 48, 49. The coolant-air heat exchanger 47 is an indoor heat exchanger. The coolant-air heat exchanger 47 is preferably arranged within the vehicle interior 3.

FIG. 2 shows the heating and cooling system 4A in a heating mode, in which the refrigerant-air heat exchanger 22 acts as a condenser to heat the vehicle interior 3. As previously mentioned, the reversing valve 10 is in its first switching position Z1. The refrigerant circuit 7 is operated as a heat pump. For this purpose, the refrigerant K is delivered from the compressor 8 via the reversing valve 10 and the line 12 to the first refrigerant-coolant heat exchanger 13. The first refrigerant-coolant heat exchanger 13 acts as a condenser. In the first refrigerant-coolant heat exchanger 13, the refrigerant K can transfer heat to the first coolant circuit 14.

The cooled refrigerant K is then supplied to the refrigerant-refrigerant heat exchanger 29 via the check valve 20 of the expansion device 17, the line 21 and via the line 28 branching off from the line 21, through which the refrigerant K can transfer heat to a countercurrent flow of the refrigerant K. Subsequently, the refrigerant K is conveyed to the throttle 34 of the expansion device 30, which causes a pressure reduction of the refrigerant K. Downstream of the throttle 34, the refrigerant K passes to the second refrigerant-coolant heat exchanger 37 which acts as an evaporator. In the second refrigerant-coolant heat exchanger 37, the refrigerant K can absorb heat from the second coolant circuit 38.

The refrigerant K then passes through the line 36 and the reversing valve 10 into the collector 45, in which the refrigerant K may be stored. From the collector 45, the temporarily stored refrigerant K can be supplied to the compressor 8 via the refrigerant-refrigerant heat exchanger 29 arranged downstream of the collector 45. In the refrigerant-refrigerant heat exchanger 29, the refrigerant K can absorb heat from the countercurrent flow of the refrigerant K. Through the compressor 8, the refrigerant K is again supplied to the line 12.

Upstream of the first refrigerant-coolant heat exchanger 13, the line 27 branches off from the line 12 to supply refrigerant K to the refrigerant-air heat exchanger 22. The refrigerant-air heat exchanger 22 thereby acts as a condenser and can thus dissipate heat from the refrigerant K to an air flow L flowing into the vehicle interior 3. The refrigerant K is returned to the line 21 via the check valve 26 of the expansion device 23.

By means of the optional coolant-air heat exchanger 47, heat from the second coolant circuit 38 can be transferred to the air flow L in the vehicle interior 3. The coolant-air heat exchanger 47 is arranged downstream of the refrigerant-air heat exchanger 22 in a flow direction of the air flow L.

The bypass line 43 may be used to bypass the second refrigerant-coolant heat exchanger 37. A switch valve may be provided for this purpose. Consequently, the refrigerant K does not flow through the second refrigerant-coolant heat exchanger 37, so that the second coolant circuit 38 can be rendered inoperative. Alternatively, the second coolant circuit 38 may be operated separately.

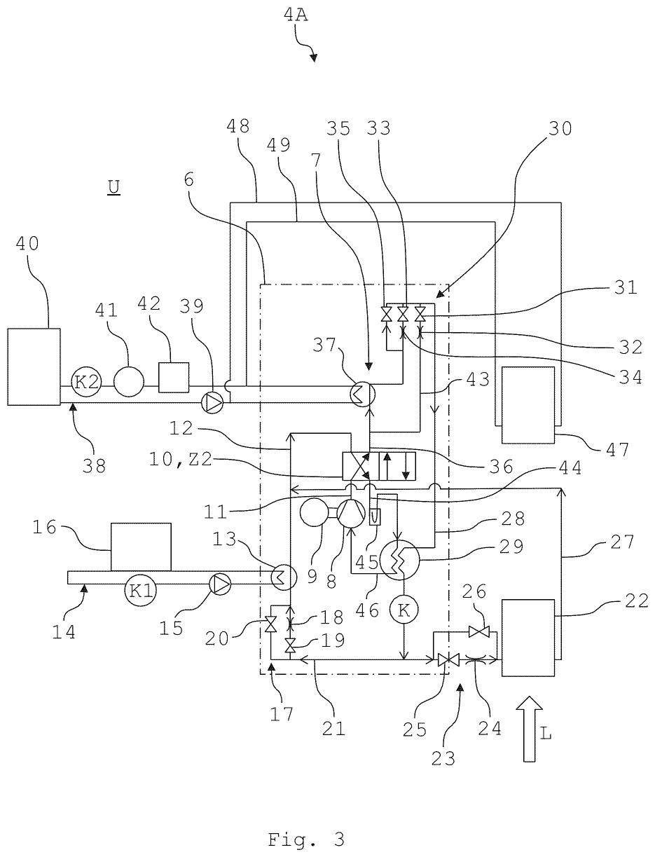

FIG. 3 shows the heating and cooling system 4A in a cooling mode, in which the refrigerant-air heat exchanger 22 acts as an evaporator to cool the vehicle interior 3. For this purpose, the reversing valve 10 is moved to a second switching position Z2 different from the first switching position Z1. In the cooling mode, the heating and cooling system 4A is operated as a refrigeration apparatus. For this purpose, the refrigerant K is supplied from the compressor 8 via the reversing valve 10 and the line 36 to the second refrigerant-coolant heat exchanger 37, which acts as a condenser in the cooling mode. The refrigerant K thereby gives off heat to the second coolant circuit 38. For example, the heat may be transferred to an environment U of the heating and cooling system 4A via the coolant-air heat exchanger 40.

The refrigerant K cooled by means of the second refrigerant-coolant heat exchanger 37 is supplied to the refrigerant-refrigerant heat exchanger 29 through the line 36, the check valve 35 of the expansion device 30, and the line 28, by means of which the refrigerant K can give further heat to a counterflow of the refrigerant K. Subsequently, the refrigerant K is supplied to the first refrigerant-coolant heat exchanger 13 via the check valve 19 and the throttle 18, which causes a pressure reduction of the refrigerant K, of the expansion device 17. The first refrigerant-coolant heat exchanger 13 acts as an evaporator, so that the refrigerant K in the first refrigerant-coolant heat exchanger 13 can absorb heat from the first coolant circuit 14.

The refrigerant K returns to the reversing valve 10 via the line 12, and from there to the collector 45. The refrigerant K delivered from the collector 45 can absorb heat from the countercurrent flow of refrigerant K via the refrigerant-refrigerant heat exchanger 29 before the refrigerant K is returned to the compressor 8.

The refrigerant-air heat exchanger 22 is supplied with refrigerant K via the line 21, as well as via the check valve 25 and the throttle 24 of the expansion device 23. The refrigerant-air heat exchanger 22 acts as an evaporator, so that it can absorb heat from the air flow L for cooling the vehicle interior 3. The refrigerant K heated in the refrigerant-air heat exchanger 22 is returned to the line 12 via the line 27.

The coolant-air heat exchanger 47 may act as a condenser, so that the air flow L cooled by the refrigerant-air heat exchanger 22 is reheated. This has the effect of dehumidifying the air flow L. This effect can be used, for example, for window clarification.

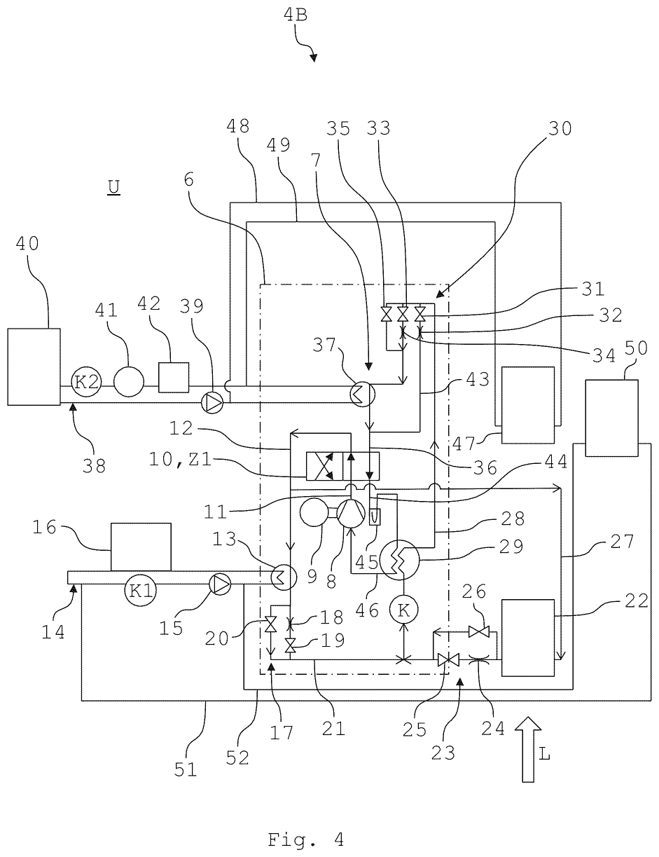

FIG. 4 shows a schematic view of a further embodiment of a heating and cooling system 4B. The heating and cooling system 4B is substantially the same as the heating and cooling system 4A, except that a further coolant-air heat exchanger 50 is provided which is in fluid communication with the first coolant circuit 14. Lines 51, 52 are provided for this purpose.

The coolant-air heat exchanger 50 is also referred to as the first coolant-air heat exchanger, as this is associated with the first coolant circuit 14. The coolant-air heat exchanger 47 is also referred to as the second coolant-air heat exchanger, as this is associated with the second coolant circuit 38.

The first coolant-air heat exchanger 50 may also be used for tempering the vehicle interior 3. The first coolant-air heat exchanger 50 is located downstream of the refrigerant-air heat exchanger 22 in the air flow L. The functionality of the heating and cooling system 4B is the same as that of the heating and cooling system 4A.

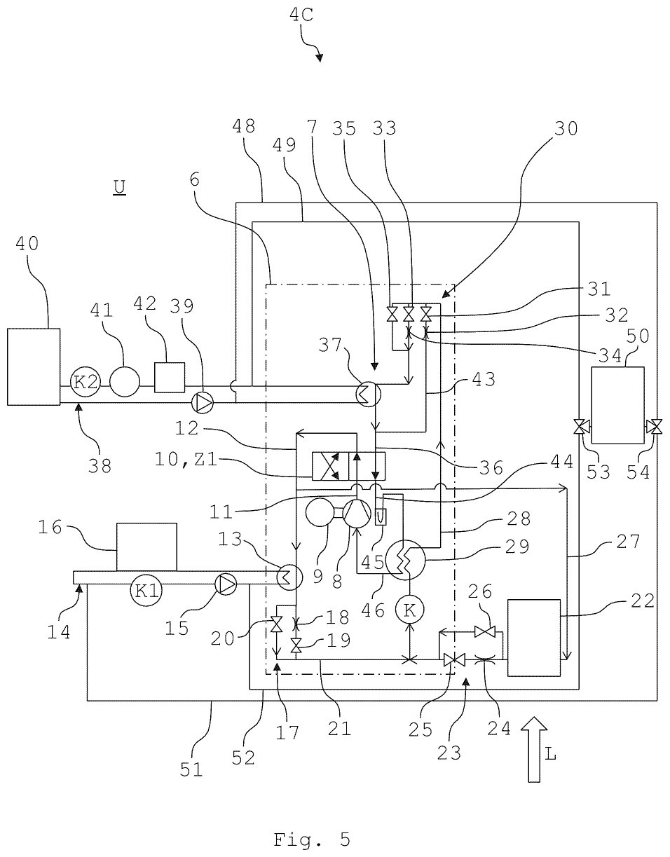

FIG. 5 shows a schematic view of a further embodiment of a heating and cooling system 4C. The heating and cooling system 4C is substantially the same as the heating and cooling system 4B except that the first coolant-air heat exchanger 50 is in fluid communication with the second coolant circuit 38 via lines 48, 49 and with the first coolant circuit 14 via lines 51, 52. The second coolant-air heat exchanger 47 is omitted in this case.

Associated with the first coolant-air heat exchanger 50 are valves 53, 54 by means of which the first coolant-air heat exchanger 50 can be brought into fluid communication with either the first coolant circuit 14 or the second coolant circuit 38. The first coolant-air heat exchanger 50 can thus be used to either heat or cool the vehicle interior 3. The functionality of the heating and cooling system 4C is otherwise the same as that of the heating and cooling system 4B.

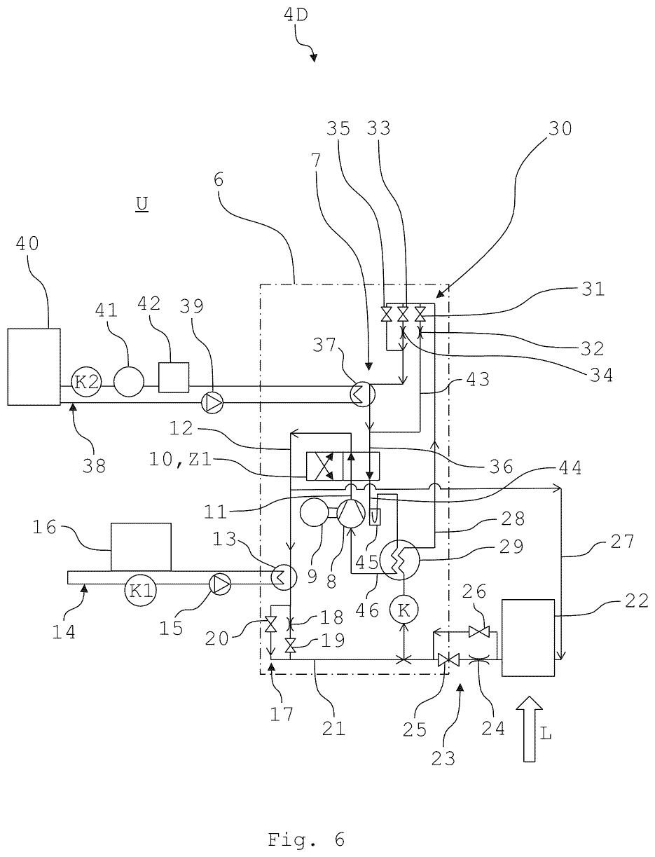

FIG. 6 shows a schematic view of a further embodiment of a heating and cooling system 4D. The heating and cooling system 4D is substantially the same as the heating and cooling system 4A except that the heating and cooling system 4D does not include a coolant-air heat exchanger 47, 50. The functionality of the heating and cooling system 4D is otherwise the same as that of the heating and cooling system 4A.

Although the present invention has been described with reference to examples of embodiments, it can be modified in a variety of ways.

### LIST OF REFERENCE SIGNS

1 Vehicle
2 Body
3 Vehicle interior
4A Heating and cooling system
4B Heating and cooling system
4C Heating and cooling system
4D Heating and cooling system
5 Engine compartment
6 Heating and cooling module
7 Refrigerant circuit
8 Compressor
9 Motor
10 Reversing valve
11 Line
12 Line
13 Refrigerant-coolant heat exchanger
14 Coolant circuit
15 Pump
16 Accumulator
17 Expansion device
18 Throttle
19 Check valve
20 Check valve
21 Line
22 Refrigerant-air heat exchanger
23 Expansion device
24 Throttle
25 Check valve
26 Check valve
27 Line
28 Line
29 Refrigerant-refrigerant heat Exchanger
30 Expansion device
31 Check valve
32 Throttle
33 Check valve
34 Throttle
35 Check valve
36 Line
37 Refrigerant-coolant heat exchanger
38 Coolant circuit
39 Pump
40 Coolant-air heat exchanger
41 Drive component
42 Drive component
43 Bypass line
44 Line
45 Collector
46 Line
47 Coolant-air heat exchanger
48 Line
49 Line
50 Coolant-air heat exchanger
51 Line
52 Line
53 Valve
54 Valve
K Refrigerant
K1 Coolant
K2 Coolant
L Air flow
U Environment
Z1 Switching position
Z2 Switching position

1. A heating and cooling system for a vehicle, comprising:
a heating and cooling module comprising a refrigerant circuit; and
a refrigerant-air heat exchanger fluidly connected to the refrigerant circuit for tempering a vehicle interior of the vehicle,
the refrigerant-air heat exchanger being provided outside the heating and cooling module.

2. The heating and cooling system according to claim 1, characterized in that
the heating and cooling module comprises a reversing valve which can be switched from a first switching position, in which the heating and cooling module operates as a heat pump, into a second switching position, in which the heating and cooling module operates as a refrigeration apparatus, and vice versa.

3. The heating and cooling system according to claim 2, characterized in that
the refrigerant-air heat exchanger functions as a condenser for heating the vehicle interior in the first switching position and as an evaporator for cooling the vehicle interior in the second switching position.

4. The heating and cooling system according to claim 2, characterized by
a first coolant circuit which is in heat transfer with the refrigerant circuit by means of a first refrigerant-coolant heat exchanger, the first refrigerant-coolant heat exchanger acting as a condenser in the first switching position and as an evaporator in the second switching position.

5. The heating and cooling system according to claim 4, characterized by
a first coolant-air heat exchanger for tempering the vehicle interior, the first coolant-air heat exchanger being in fluid communication with the first coolant circuit.

6. The heating and cooling system according to claim 5, characterized in that
the refrigerant-air heat exchanger is connected upstream of the first refrigerant-air heat exchanger.

7. The heating and cooling system according to claim 2, characterized by
a second coolant circuit which is in heat transfer with the refrigerant circuit by means of a second refrigerant-coolant heat exchanger, the second refrigerant-coolant heat exchanger acting as an evaporator in the first switching position and as a condenser in the second switching position.

8. The heating and cooling system according to claim 7, characterized by
a second coolant-air heat exchanger for tempering the vehicle interior, the second coolant-air heat exchanger being in fluid communication with the second coolant circuit.

9. The heating and cooling system according to claim 8, characterized in that
the refrigerant-air heat exchanger is connected upstream of the second coolant-air heat exchanger.

10. The heating and cooling system according to claim 7, characterized in that
the second coolant circuit comprises a coolant-air heat exchanger for delivering and receiving heat to and from an environment of the heating and cooling system.

11. The heating and cooling system according to claim 1, characterized by
lines leading away from the heating and cooling module, the refrigerant-air heat exchanger being in fluid communication with the refrigerant circuit by means of the lines.

12. The heating and cooling system according to claim 1, characterized in that
the heating and cooling module is block shaped.

13. Vehicle, in particular electric vehicle or hybrid vehicle, comprising a heating and cooling system according to claim 1, the refrigerant-air heat exchanger being provided in or on the vehicle interior.

14. The vehicle according to claim 13,
characterized in that
the heating and cooling module is provided in or on an engine compartment of the vehicle.

15. The vehicle according to claim 13,
characterized by
an accumulator and/or drive components, the heating and cooling system being configured to temper the accumulator and/or the drive components.
